(19) United States
(12) Patent Application Publication
(10) Pub. No.: US 2008/0317571 A1
(43) Pub. Date: Dec. 25, 2008

(54) Seated lift for recreational vehicles

(76) Inventor: Garlin Cheatham, JR., Hartselle, AL (US)

Correspondence Address: LANIER FORD SHAVER & PAYNE P.C., P O BOX 2087, HUNTSVILLE, AL, 35804-2087, US

(21) Appl. No.: 11/820,853

(22) Filed: Jun. 21, 2007

(51) Int. Cl. A61G 3/06

(52) U.S. Cl. 414/541

(57) ABSTRACT

A lift apparatus for a motor home or recreational vehicle is provided having a generally vertical slide rail attached to the cabin floor and interior wall adjacent the doorway to the motor home. A trolley is slidably engaged with the slide rail and is configured for vertical movement through the selectively motorized rotation of pulleys about which is engaged a line attached at each end to the trolley. A riser is hingedly connected to the trolley, and a swing arm is hingedly connected to the riser. The distal end of the swing arm is configured to have a chair removably mounted to it.

### BRIEF DESCRIPTION OF THE DRAWINGS

The present invention is described with reference to the accompanying drawings. In the drawings, like reference numbers indicate identical or functionally similar elements. Additionally, the leftmost digit(s) of a reference number identifies the drawing in which the reference number first appears.

FIG. 1 is a perspective view of an exemplary lift apparatus;

FIG. 2 is an elevational view of the lift apparatus of FIG. 1;

FIG. 3A is an elevational view of an alternative embodiment of the lift apparatus of FIG. 1;

FIG. 3B is an elevational view of a further alternative embodiment of the lift apparatus

FIG. 4 is a perspective view of the lift apparatus installed in a recreational vehicle; and

FIG. 4B illustrates the exterior of the recreational vehicle into which the lift apparatus is installed.

### DETAILED DESCRIPTION

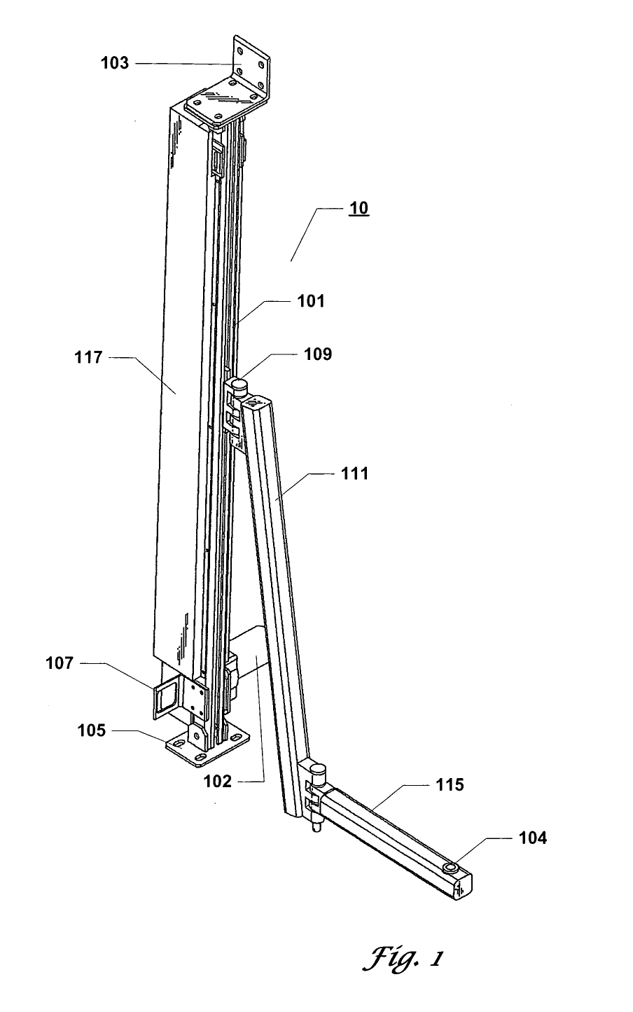

The various embodiments of the present invention and their advantages are best understood by referring to FIGS. 1 through 4 of the drawings. The elements of the drawings are not necessarily to scale, emphasis instead being placed upon clearly illustrating the principles of the invention. Throughout the drawings, like numerals are used for like and corresponding parts of the various drawings.

The drawings represent and illustrate examples of the various embodiments of the invention, and not a limitation thereof. It will be apparent to those skilled in the art that various modifications and variations can be made in the present inventions without departing from the scope and spirit of the invention as described herein. For instance, features illustrated or described as part of one embodiment can be included in another embodiment to yield a still further embodiment. Moreover, variations in selection of materials and/or characteristics may be practiced to satisfy particular desired user criteria. Thus, it is intended that the present invention covers such modifications as come within the scope of the features and their equivalents.

Furthermore, reference in the specification to “an embodiment,” “one embodiment,” “various embodiments,” or any variant thereof means that a particular feature or aspect of the invention described in conjunction with the particular embodiment is included in at least one embodiment of the present invention. Thus, the appearance of the phrases “in one embodiment,” “in another embodiment,” or variations thereof in various places throughout the specification are not necessarily all referring to its respective embodiment.

Shown in FIG. 1, an embodiment of the exemplary lift apparatus 10 includes a generally vertical slide rail member 101 capped by mounting brackets 103, 105 on either end. Motor 102 is mounted via a bracket, to the rail 101, preferably on the lower end. Another bracket 107 may be mounted in the vicinity of the motor to provide support for a wiring harness and/or coupling means that will be described in greater detail below. In this exemplary embodiment, slide rail 101 is a “c” frame having a vertical hollow defined by the rail frame and leaving a slot extending the length of the rail.

A trolley 109 is slidably engaged with the rail 101, by, for example, being seated within the slot of the rail and having lateral extensions which engage the inner portion of the rail frame. Such lateral extensions may be wheeled to provide substantially frictionless movement within the slide rail hollow. The trolley 109 is hingedly connected to angled riser member 111 which is in turn hingedly connected to a generally horizontal swing arm 115. Swing arm 115 includes a mounting aperture 104 defined in the free end to receive a post extending from the bottom of a chair when the apparatus is fully installed. A cowling 117 may be included as well.

With reference to FIG. 2, near the respective top and bottom ends are mounted pulleys 203, 205 around which a chain 208, cord, or rope is engaged. One end of the chain 208 is attached to the upper portion of the trolley 109 while the other end of the chain 208 is attached to the lower portion of the trolley 109. Motor 102 is rotatably coupled to a pulley (in the embodiment described, the lower pulley). It will be apparent to those skilled in the art that coupling the motor to the upper pulley 205, would result in torque applied to the upper portion of the rail 101, which may be undesirable.

In operation, motor 102 applies torque to the pulley 109 which rotates and pulls the chain 208 in one of two directions, which in turn, causes the trolley 109 to move along the rail in one of two directions depending upon the direction of movement selected by the operator. Cowling 117 covers the moving parts and reduces the likelihood of foreign objects becoming insinuated in the chain or pulley during operation and the likelihood of injury.

FIG. 4 illustrates the apparatus 10 installed in a recreational vehicle. Recreational vehicles typically include a doorway 423 through which a person may enter the cabin via a stairwell 404 which leads to the main deck 401 of the cabin. The lift apparatus 10 is installed against the vehicle bulkhead 427 roughly adjacent the doorway 423 by fasteners inserted into apertures in upper and lower mounting brackets 103, 105, and through corresponding apertures in the vehicle bulkhead 427 and main deck 401, respectively. Lift apparatus 10 is installed so that angled riser 111 extends down into the stairwell 404 and swing arm 115 may extend in within the doorway. Upper mounting bracket 103 is shown to be mounted against the interior bulkhead 427. As shown in FIG. 4B, a plate 481 affixed to the exterior vehicle wall by the fasteners securing the upper bracket 103 to the interior bulkhead 427. This provides support for the wall to prevent tearing or cracking thereof. Chair 491 is set upon the swing arm 115 and is allowed to pivot. Chair 491 is therefore configured with a post extending from the under side of its seat portion that is removably inserted into swing arm aperture 104.

Motor 102 is mounted to a bracket affixed to the inward portion of the rail 101 and its operation is controlled with a control switch 475 coupled thereto with control wiring 473. Wiring 473 may be removably coupled to motor 102 through wiring bracket 107 mounted near the motor 102. Motor may be any suitable electric motor capable of imparting torque to the pulley system, and should preferably be capable of bi-directional operation in order to enable up and down movement of the trolley. For example, motor could be a 12 Volt motor. Control switch 475 should therefore also be configured to provide suitable bi-directional control to the operator. In other words, the operator needs to be able to command forward and reverse operation of the motor.

Operation of the lift apparatus will now be described. To enter the vehicle, the trolley should be at its lowest point. Swing arm 115 (with chair 491) is rotated through the doorway 423 to the exterior of the vehicle, along with riser 111, by virtue of their respective hinged connections. The operator sits in the chair 491, and using the control switch 475, commands the motor 102 to rotate the pulley 205 causing the trolley 109 and the chair 491 to elevate. Once at the desired height, the operator may command the motor 102 to stop, and rotate the swing arm 115 with the chair 491 to the interior of the vehicle.

It will be appreciated that the lift disclosed herein is useful for those who are incapable of ascending stairs to enter such vehicles. Accordingly, angled riser 111 should be of a length such that when the trolley is at its upper most point, the user may simply stand up from the chair and rest his or her feet on the main deck 401. Further, the angle of the riser should be of a degree that given the length of the riser and the length of the swing arm, a chair mounted to the swing arm is centered within the width of the doorway.

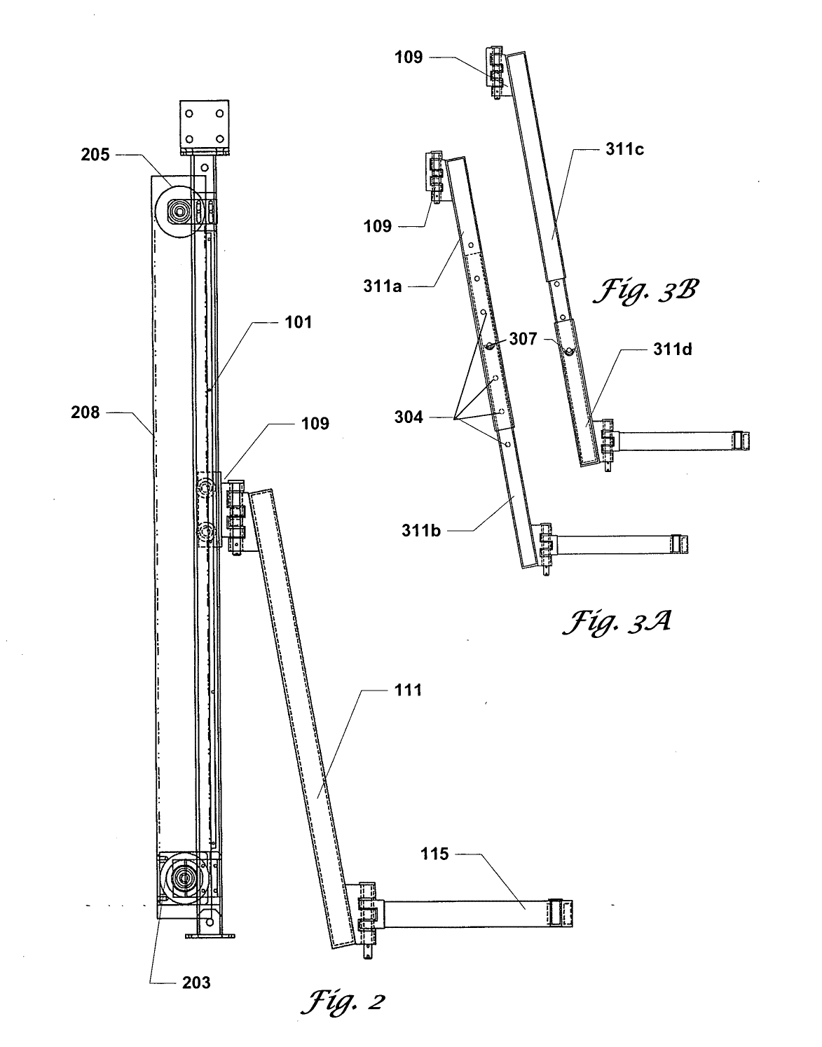

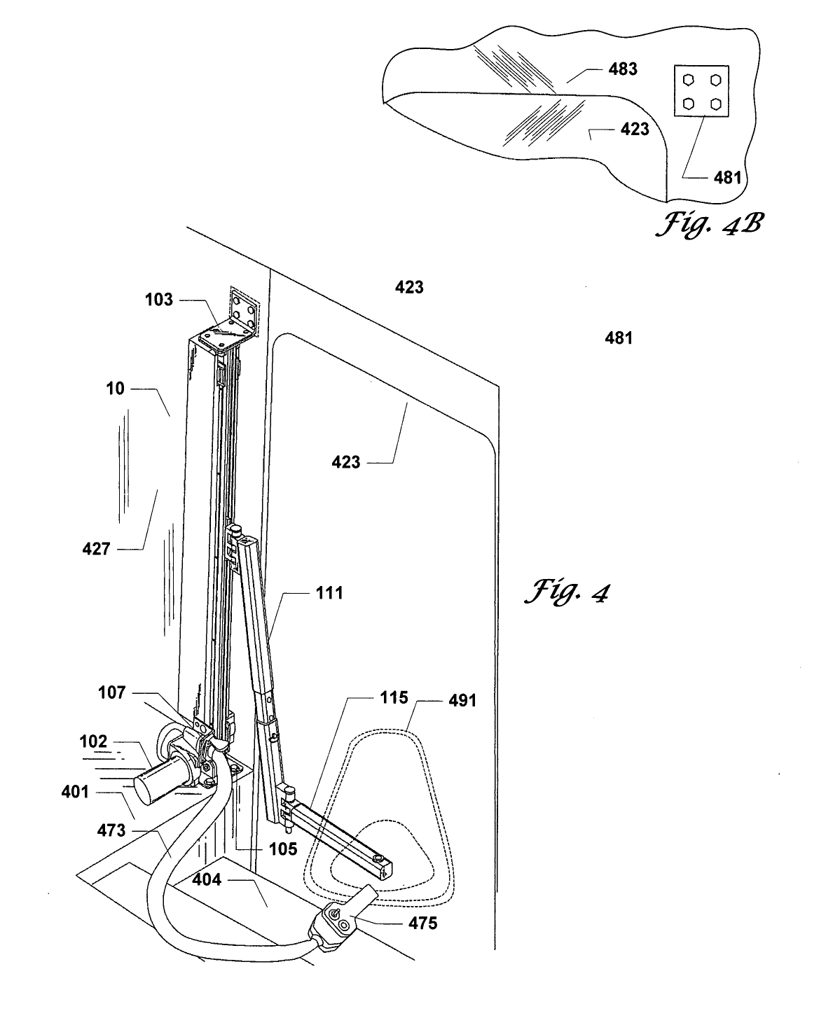

In an alternative embodiment, angled riser is adjustable in length. For example, as shown in FIG. 3A, the upper portion of angle riser 311a is hollow and is open at its lower end, dimensioned to receive the lower portion 311b of the riser. Each portion includes corresponding, spaced-apart holes bored through the respective portion, into which may be inserted a pin 307. In this manner, the length of angled riser 111 may be shortened or lengthened. In the alternative, FIG. 3B shows a version where upper portion 311c is received within the lower portion 311d. Each portion includes corresponding, spaced-apart holes bored through the respective portion, into which may be inserted a pin.

The ability to adjust allows the lift apparatus to be used when the vehicle is parked perpendicular to a downward slope, or decline. In such condition, the side of the vehicle toward the decline is usually raised by jacks or stabilizing feet so that the vehicle may be leveled. The riser length may be suitable for use in situations where the vehicle is parked on level ground, but if the vehicle is parked on a decline as described above, the chair may be too high for someone to sit in if trying to enter the vehicle, or too high from which to alight to the ground if exiting, and the lift apparatus would be useless. Thus, the riser may be adjustable to extend the chair and swing arm lower in those situations.

The above-described lift has many advantages over known lifts used in the industry. Such pre-existing lifts are installed on the outside of the vehicle adding width. They are also installed by the manufacturer and result in modifications to the frame and removal of storage space within the vehicle. Specifically, typical prior art lifts require the doorway to be widened to place the chair into the center of the doorway when the chair is lifted. Manufacturers typically realize greater profit on uniformity of frame and the furnishings inside the RV. Such modifications result in increased cost through not only the labor and time involved, but also in redesign and refurnishing of the interior of the RV.

The present lift may be installed by anyone with only modification to the bulkhead and cabin floor, and thus, is suitable for use in any standard RV configured as described above. For travel and for unassisted entry/exit of the vehicle, the chair may be easily removed and the riser/swing arm assembly folded to the interior of the vehicle, out of the stairwell. Further, the lifts are installed so that all storage space is still usable.

As described above and shown in the associated drawings, the present invention comprises a seated lift for recreational vehicles. While particular embodiments of the invention have been described, it will be understood, however, that the invention is not limited thereto, since modifications may be made by those skilled in the art, particularly in light of the foregoing teachings. It is, therefore, contemplated by the following claims to cover any such modifications that incorporate those features or those improvements that embody the spirit and scope of the present invention.

What is claimed is:

1. A lift apparatus for recreational vehicles that include a doorway within which is an interiorly disposed stairwell leading up to a cabin, the cabin having a floor and defined by interior walls, said lift apparatus comprising:
a. a generally vertical rail member having a first mounting bracket attached to a bottom end thereof for mounting said bottom end to the cabin floor in proximity to the doorway, and a second mounting bracket attached to a top end of said rail for securing said top end to the interior wall of the cabin;
b. a trolley slidably engaged with said rail member;
c. a first and second pulleys mounted to said rail member near said top and bottom ends, respectively, said first and second pulleys rotatably engaged with a line having a first end attached to a top end of said trolley and a second end attached to a bottom end of said trolley;
d. a motor mechanically coupled to one of said first and second pulleys operable for selectively applying torque to said coupled pulley, whereby said line is pulled in either direction to slide said trolley up or down said rail member;
e. an angled riser member hingedly coupled to said trolley and extending downward toward the stairwell; and
f. a swing arm hingedly coupled to said riser member extending across said stairwell.

2. The lift apparatus of claim 1, wherein said swing arm includes a mounting aperture defined in the distal end thereof for receiving a post extending from the underside of a chair.

3. The lift apparatus of claim 2, wherein said riser member is angled such that when said chair is mounted to said swing arm, said chair is roughly centered within the doorway

4. The lift apparatus of claim 1, wherein said motor is a 12 Volt electric motor.

5. The lift apparatus of claim 1, further comprising a cover affixed to the rail over the first and second pulleys.

6. The lift apparatus of claim 1, further comprising a mounting support plate mounted to an exterior wall opposite said second mounting bracket secured to said interior wall.

7. The lift apparatus of claim 1, wherein said riser member is adjustable in length.

8. The lift apparatus of claim 7, wherein said swing arm includes a mounting aperture defined in the distal end thereof for receiving a post extending from the underside of a chair.

9. The lift apparatus of claim 8, wherein said riser member is angled such that when said chair is mounted to said swing arm, said chair is roughly centered within the doorway.

10. The lift apparatus of claim 9, wherein said motor is a 12 Volt electric motor.

11. The lift apparatus of claim 9, further comprising a cover affixed to the rail over the first and second pulleys.

12. The lift apparatus of claim 9, further comprising a mounting support plate mounted to an exterior wall opposite said second mounting bracket secured to said interior wall.

13. The lift apparatus of claim 9, wherein said riser member is adjustable in length.
